(19) United States
(12) Patent Application Publication
(10) Pub. No.: US 2012/0162158 A1
(43) Pub. Date: Jun. 28, 2012

(54) DISPLAY APPARATUS SET

(75) Inventors: Nam-Gon CHOI, Asan-si (KR); Jae-Gwan JEON, Incheon (KR); Jaehyoung PARK, Asan-si (KR)

(73) Assignee: SAMSUNG ELECTRONICS CO., LTD., Suwon-si (KR)

(21) Appl. No.: 13/170,710

(22) Filed: Jun. 28, 2011

(30) Foreign Application Priority Data
Dec. 28, 2010 (KR) 10-2010-0136960

(51) Int. Cl. G09G 5/00

(52) U.S. Cl. 345/204

(57) ABSTRACT

A display apparatus set includes a signal receiver/transmitter, a scaler, a driving circuit, and a first display panel. The signal receiver/transmitter receives an image signal from an external device, outputs a portion of the image signal as a first image signal, and outputs a remaining portion of the image signal as a second image signal. The scaler receives the first image signal and converts a size and a resolution of an image included in the first image signal to output the converted first image signal. The driving circuit receives the converted first image signal and converts the converted first image signal to output a data signal. The first display panel receives the data signal to display an image. The second image signal is similarly treated and displayed on a second display panel.

### CROSS REFERENCE TO RELATED APPLICATION

This application claims priority from and the benefit of Korean Patent Application No. 10-2010-0136960, filed on Dec. 28, 2010, which is hereby incorporated by reference for all purposes as if fully set forth herein.

### BACKGROUND

1. Field of the Invention

Exemplary embodiments of the present invention relate to a display apparatus set and, more particularly, to a display apparatus set having a display apparatus that may transmit a portion of received image signals to another display apparatus.

2. Discussion of the Background

In general, a display apparatus receives an image signal and a control signal from an external device, for example a set-top box, to display an image. Various display apparatuses have been used such as a liquid crystal display, a plasma display apparatus, an organic light emitting display apparatus, and an electrophoretic display apparatus.

When more than one display is used, each typically is connected to its own dedicated set-top box. As a result, additional costs accrue due to added set-top boxes, and the displays usually are driven independently from each other.

### SUMMARY OF THE INVENTION

Exemplary embodiments of the present invention provide a display apparatus set having a display apparatus capable of transmitting a portion of received image signals to another display apparatus.

Additional features of the invention will be set forth in the description which follows, and in part will be apparent from the description, or may be learned by practice of the invention.

An exemplary embodiment of the present invention discloses a display apparatus set that comprises a first signal receiver/transmitter configured to receive an image signal, to output a portion of the image signal as a first image signal, and to output a remaining portion of the image signal as a second image signal; a first scaler configured to receive the first image signal, to convert a size and a resolution of an image included in the first image signal, and to output the converted first image signal; a first driver circuit configured to receive the converted first image signal, to convert the converted first image signal into a first data signal, and to output the first data signal; and a first display panel configured to receive the first data signal to display an image.

An exemplary embodiment of the present invention also discloses a display apparatus set that comprises a first display apparatus configured to receive an image signal, to display an image corresponding to a first image signal that comprises a portion of the image signal, and to output a second image signal that comprises a remaining portion of the image signal; and a second display apparatus configured to receive the second image signal output from the first display apparatus to display an image corresponding to the second image signal.

An exemplary embodiment of the present invention further discloses a display apparatus set that comprises a first signal receiver/transmitter configured to receive an image signal, to output a portion of the image signal as a first image signal, and to output a remaining portion of the image signal as a second image signal; a second signal receiver/transmitter configured to receive the second image signal and to output the second image signal; a first display panel configured to receive the first data signal from the first signal receiver/transmitter to display a first image; and a second display panel configured to receive the second data signal from the second signal receiver/transmitter to display a second image.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a display apparatus set according to an exemplary embodiment of the present invention.

FIG. 2 is a block diagram showing a first signal receiver/transmitter of FIG. 1.

FIG. 3 is a block diagram showing a first display part of FIG. 1.

FIG. 4 is a block diagram showing a scaler of FIG. 3.

FIG. 5 is a block diagram showing a method of displaying an image using a display apparatus set according to an exemplary embodiment of the present invention.

FIG. 6 is a view showing a process of transmitting an image according to the method shown in FIG. 5.

FIG. 7 is a block diagram showing a method of displaying an image using a display apparatus set according to another exemplary embodiment of the present invention.

FIG. 8 is a view showing a process of transmitting an image according to the method shown in FIG. 7.

FIG. 9 is a plan view showing a display apparatus set according to an exemplary embodiment of the present invention.

FIG. 10 is a partially enlarged view of a portion AA of FIG. 9.

FIG. 11 is a plan view showing a display apparatus set according to another exemplary embodiment of the present invention.

FIG. 12 is a plan view showing a display apparatus set according to another exemplary embodiment of the present invention.

### DETAILED DESCRIPTION OF THE ILLUSTRATED EMBODIMENTS

The invention is described more fully hereinafter with reference to the accompanying drawings in which embodiments of the invention are shown. This invention may, however, be embodied in many different forms and should not be construed as limited to the embodiments set forth herein. Rather, these embodiments are provided so that this disclosure is thorough and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on,” “connected to,” or “coupled to” another element or layer, it can be directly on, directly connected to, directly coupled to the other element or layer, or intervening elements or layers may be present. In contrast, when an element is referred to as being “directly on,” “directly connected to,” or “directly coupled to” another element or layer, there are no intervening elements or layers present.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

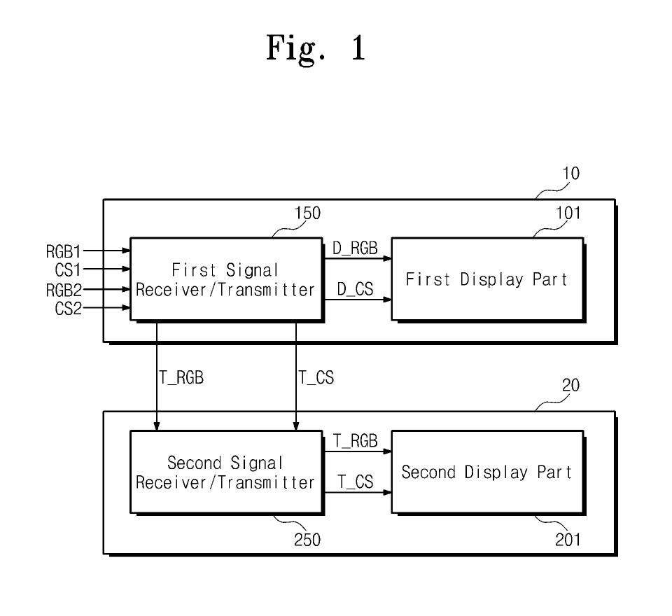

FIG. 1 is a block diagram showing a display apparatus set according to an exemplary embodiment of the present invention.

Referring to FIG. 1, a display apparatus set includes a first display apparatus 10 and a second display apparatus 20.

The first display apparatus 10 includes a first signal receiver/transmitter 150 and a first display part 101, and the second display apparatus 20 includes a second signal receiver/transmitter 250 and a second display part 201.

The first signal receiver/transmitter 150 receives a first image signal RGB1, a first control signal CS1 used to display the first image signal RGB1, a second image signal RGB2, and a second control signal CS2 used to display the second image signal RGB2 from an external device, for example, a set-top box.

The first signal receiver/transmitter 150 transmits the image signal and the control signal, which are related to an image displayed on the first display part 101, to the first display part 101 as a driving image signal D_RGB and a driving control signal D_CS and transmits the image signal and the control signal, which are related to an image displayed on the second display apparatus 20, to the second display apparatus 20 as a transmission image signal T_RGB and a transmission control signal T_CS.

The second signal receiver/transmitter 250 receives the transmission image signal T_RGB and the transmission control signal T_CS and transmits the transmission image signal T_RGB and the transmission control signal T_CS to the second display part 201. The second display part 201 receives the transmission image signal T_RGB and the transmission control signal T_CS from the second signal receiver/transmitter 250 to display an image corresponding to the transmission image signal T_RGB and the transmission control signal T_CS.

In FIG. 1, the first display apparatus 10 that receives the first image signal RGB1 and the second image signal RGB2 from the external device has been shown, but it is not limited thereto. That is, the second display apparatus 20 may receive the first image signal RGB1 and the second image signal RGB2 from the external device and transmit a portion of each of the first and second image signals RGB1 and RGB2 to the first display apparatus 10.

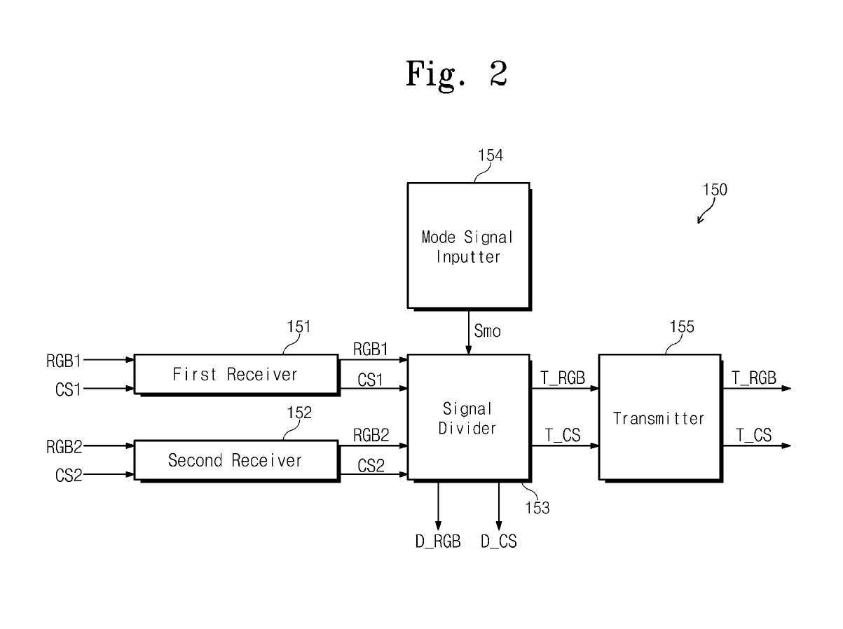

FIG. 2 is a block diagram showing a first signal receiver/transmitter of FIG. 1.

Referring to FIG. 2, the first signal receiver/transmitter 150 includes a first receiver 151, a second receiver 152, a signal divider 153, a mode signal inputter 154, and a transmitter 155.

The first receiver 151 receives the first image signal RGB1 corresponding to a first image and the first control signal CS1 and applies the first image signal RGB1 and the first control signal CS1 to the signal divider 153, and the second receiver 152 receives the second image signal RGB2 corresponding to a second image different from the first image and the second control signal CS2 and applies the second image signal RGB2 and the second control signal CS2 to the signal divider 153. In the present exemplary embodiment, the first and second image signals RGB1 and RGB2 are provided through separate channels, but the first and second image signals RGB1 and RGB2 may be provided through one signal line.

The mode signal inputter 154 provides a mode signal Smo, which is related to an image display mode of the first display apparatus 10, to the signal divider 153 according to, e.g., a user's instructions. The mode signal Smo includes a single mode signal and a dual mode signal. The single mode signal is provided to the signal divider 153 when the first and second display apparatuses 10 and 20 are independently driven to display separate images, and the dual mode signal is provided to the signal divider 153 when the first and second display apparatuses 10 and 20 are dependently driven to display one image. As an example, the mode signal inputter 154 may be a remote control.

According to the mode signal Smo, the signal divider 153 provides signals related to the image displayed on the first display part 101 to the first display part 101 as the driving image signal D_RGB and the driving control signal D_CS and provides signals, which are related to the image displayed on the second display part 201, to the second display part 201 as the transmission image signal T_RGB and the transmission control signal T_CS.

In detail, the driving image signal D_RGB and the driving control signal D_CS may be, e.g., (a) all or a portion of the first image signal RGB1 and the first control signal CS1 or (b) all or a portion of the second image signal RGB2 and the second control signal CS2. In addition, the transmission image signal T_RGB and the transmission control signal T_CS may be, e.g., (a) all or a portion of the first image signal RGB1 and the first control signal CS1 or (b) all or a portion of the second image signal RGB2 and the second control signal CS2.

The transmitter 155 receives the transmission image signal T_RGB and the transmission control signal T_CS and transmits both of them to the second display apparatus 20. The transmitter 155 may transmit the transmission image signal T_RGB and the transmission control signal T_CS through a wired or wireless connection. In detail, if the first and second display apparatuses 10 and 20 are positioned close to each other, the transmitter 155 may transmits the transmission image signal T_RGB and the transmission control signal T_CS via the wired connection. If the first and second display apparatuses 10 and 20 are spaced apart from each other, the transmitter 155 may transmit the transmission image signal T_RGB and the transmission control signal T_CS via the wireless connection.

Although not shown in figures, the second signal receiver/transmitter 250 may have a structure the same as or similar to that of the first signal receiver/transmitter 150.

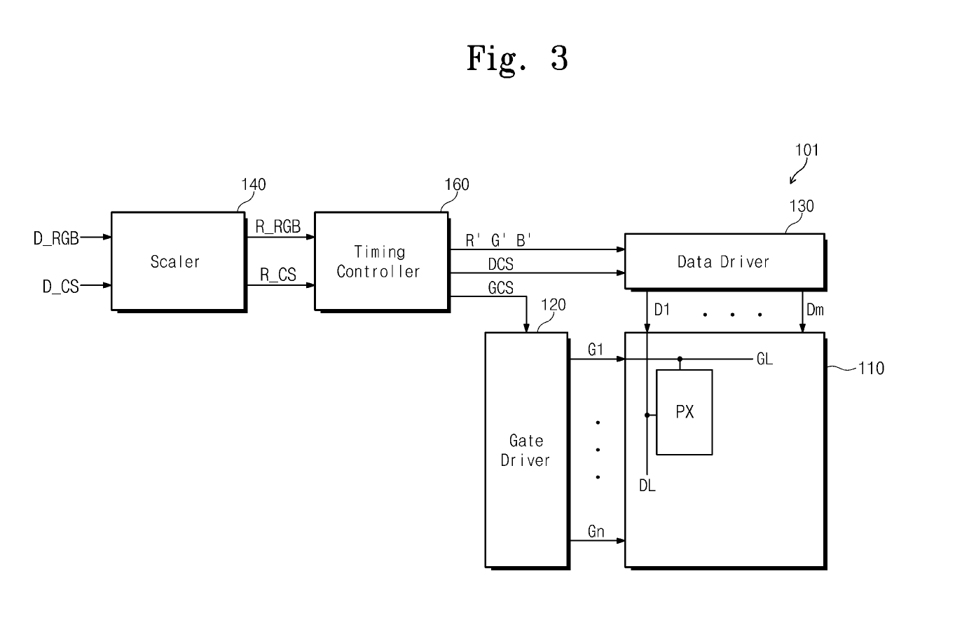

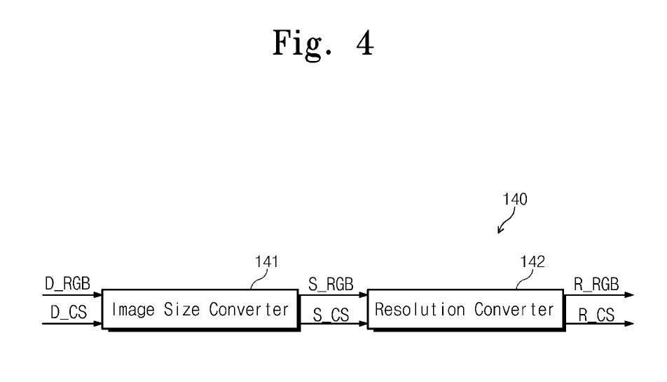

FIG. 3 is a block diagram showing a first display part of FIG. 1, and FIG. 4 is a block diagram showing a scaler of FIG. 3.

The first display part 101 includes a display panel 110, a gate driver 120, a data driver 130, a timing controller 160, and a scaler 140.

Referring to FIG. 2, FIG. 3, and FIG. 4, the scaler 140 receives the driving image signal D_RGB and the driving control signal D_CS from the signal divider 153, converts the driving image signal D_RGB and the driving control signal D_CS in consideration of a size and a resolution of the display panel 110, and provides the converted driving image signal R_RGB and the converted driving control signal R_CS to the timing controller 160.

In detail, the scaler 140 includes an image size converter 141 and a resolution converter 142.

The image size converter 141 receives the driving image signal D_RGB and the driving control signal D_CS from the signal divider 153, converts the size of the driving image signal D_RGB and the size of the driving control signal D_CS in consideration of the size and the resolution of the display panel 110, and provides the size-converted driving image signal S_RGB and the size-converted driving control signal S_CS to the resolution converter 142.

Particularly, in the case that the driving image signal D_RGB from the signal divider 153 is a signal corresponding to an image having an aspect ratio of 8:9, the image size converter 141 may convert the driving image signal D_RGB to a signal corresponding to an image having an aspect ratio of 16:9. On the contrary, in the case that the driving image signal D_RGB from the signal divider 153 is the signal corresponding to the image having the aspect ratio of 16:9, the image size converter 141 may convert the driving image signal D_RGB to the signal corresponding to the image having the aspect ratio of 8:9. The aspect ratios are merely for illustration, and many other aspect ratios may be used. Additionally, the image size converter 141 may perform a one-to-one conversion where the driving image signal D_RGB from the signal divider 153 is a signal corresponding to an image having an aspect ratio of, e.g., 16:9, and the image size converter 141 may convert the driving image signal D_RGB aspect ratio to a signal corresponding to an image having an aspect ratio of 16:9, i.e., the driving image signal D_RGB and the post-conversion signal have the same image aspect ratios.

The resolution converter 142 receives the size-converted driving image signal S_RGB and the size-converted driving control signal S_CS. If necessary, the resolution converter 142 converts the resolution of the size-converted driving image signal S_RGB and the size-converted driving control signal S_CS to provide the resolution-converted driving image signal R_RGB and the resolution-converted driving control signal R_CS.

In particular, the scaler 140 may convert the size of the driving image signal D_RGB and the resolution of the size-converted driving image signal S_RGB using a bilinear interpolation or a bicubic interpolation, but other interpolation methods may also be used. The interpolation method may be chosen to optimize the conversion processing speed and fidelity of the resultant signals.

In FIG. 3 and FIG. 4, the scaler 140 is configured to be separated from the timing controller 160, but other options are possible. For example, the scaler 140 may be integrated into the timing controller 160.

Referring to FIG. 3, the timing controller 160 receives the resolution-converted driving image signal R_RGB and the resolution-converted driving control signal R_CS from the scaler 140, converts a data format of the resolution-converted driving image signal R_RGB appropriate to interface between the data driver 130 and the timing controller 160, and provides the format-converted image signal R′G′B′ to the data driver 130. In addition, the timing controller 160 provides a data control signal DCS, such as an output start signal, a horizontal start signal, etc., to the data driver 130. The timing controller 160 provides a gate control signal GCS, such as a vertical start signal, a vertical clock signal, a vertical clock bar signal, etc., to the gate driver 120.

The gate driver 120 sequentially outputs gate signals G1 to Gn in response to the gate control signal GCS provided from the timing controller 160.

The data driver 130 converts the format-converted image signal R′G′B′ to data voltages D1 to Dm in response to the data control signal DCS provided from the timing controller 160. The data voltages D1 to Dm are applied to the display panel 110.

The display panel 110 includes a plurality of gate lines GL, a plurality of data lines DL crossing the gate lines GL, and a plurality of pixels PX. Since the pixels PX have the same structure and function, for the convenience of explanation, one pixel has been shown in FIG. 3.

The gate lines GL are connected to the gate driver 120, and the data lines DL are connected to the data driver 130. The gate lines GL receive the gate signals G1 to Gn provided from the gate driver 120, and the data lines DL receive the data voltages D1 to Dm provided from the data driver 130.

Although not shown in FIG. 3, each pixel PX may include a switch such as a thin film transistor. The thin film transistor turns on in response to a corresponding gate signal of the gate signals G1 to Gn provided through a corresponding gate line of the gate lines GL to provide a corresponding data voltage of the data voltages D1 to Dm provided through a corresponding data line of the data lines DL.

Although not shown in figures, the second display part 201 may have a structure that is similar to that of the first display part 101.

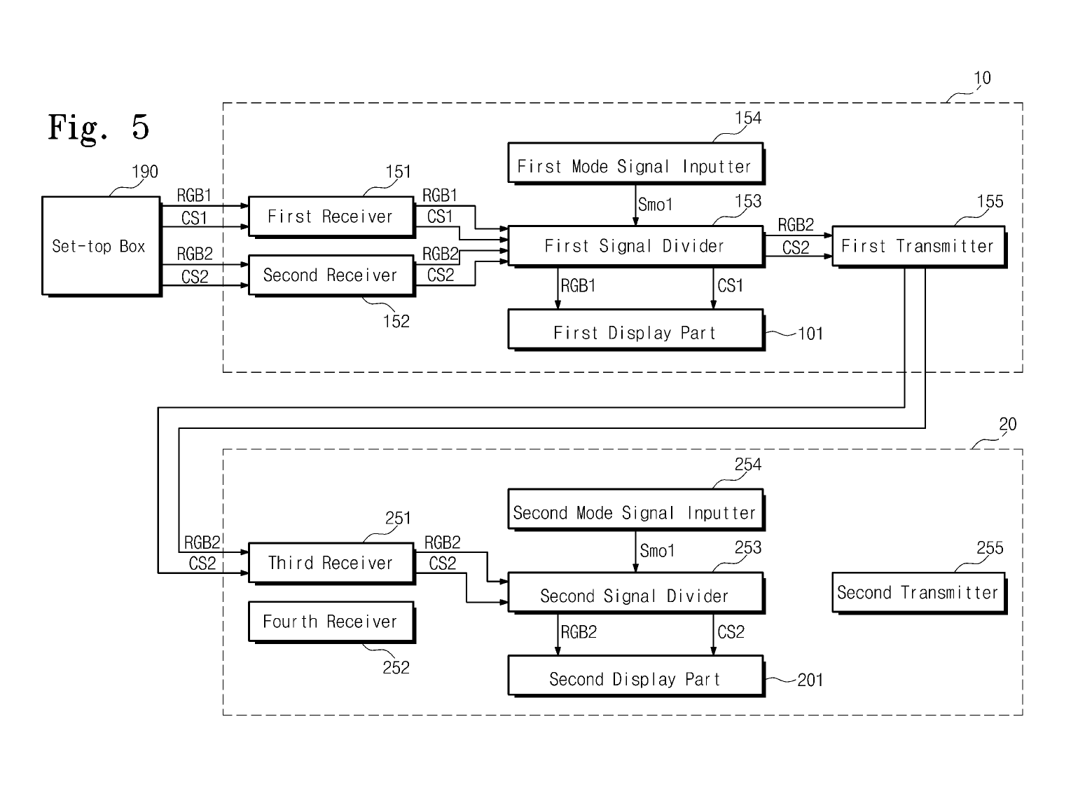

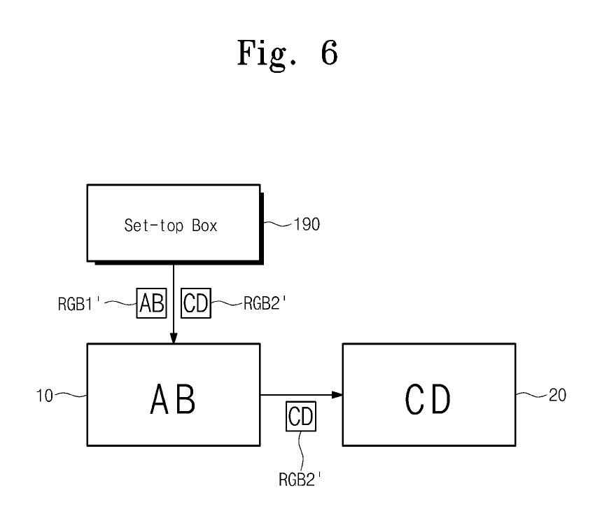

FIG. 5 is a block diagram showing a method of displaying an image using a display apparatus set according to an exemplary embodiment of the present invention, and FIG. 6 is a view showing a process of transmitting an image according to the method shown in FIG. 5.

Referring to FIG. 5 and FIG. 6, the first display apparatus 10 receives the first image signal RGB1 corresponding to the first image, the first control signal CS1, the second image signal RGB2 corresponding to the second image, and the second control signal CS2 from the external device 190, i.e., the set-top box. In FIG. 6, the first image RGB1′ is used to display an image of “AB”, and the second image RGB2′ is used to display an image of “CD”.

The first display apparatus 10 displays the first image RGB1′ corresponding to the first image signal RGB1 using the first image signal RGB1 and the first control signal CS1 and outputs the second image signal RGB2 and the second control signal CS2 to the second display apparatus 20.

The second display apparatus 20 receives the second image signal RGB2 and the second control signal CS2 to display the second image RGB2′ corresponding to the second image signal RGB2.

In detail, referring to FIG. 5, the first receiver 151 receives the first image signal RGB1 and the first control signal CS1 from the set-top box 190 to output the first image signal RGB1 and the first control signal CS1 to the first signal divider 153, and the second receiver 152 receives the second image signal RGB2 and the second control signal CS2 from the set-top box 190.

In FIG. 5, the first image signal RGB1 and the second image signal RGB2 are shown as having been received through separate channels, but the first and second image signals RGB1 and RGB2 may be received using one receiver and one channel.

When the single mode signal Smo1 is applied to the first signal divider 153 from the first mode signal inputter 154 by a source, e.g., the user, the first signal divider 153 outputs the first image signal RGB1 and the first control signal CS1 to the first display part 101 and outputs the second image signal RGB2 and the second control signal CS2 to the first transmitter 155. The first transmitter 155 may transmit the second image signal RGB2 and the second control signal CS2 to a third receiver 251 via a wired or wireless connection.

Referring to FIG. 5 and FIG. 6, the first display part 101 displays “AB”, which is the first image RGB1′ corresponding to the first image signal RGB1, using the first image signal RGB1 and the first control signal CS1.

The third receiver 251 receives the second image signal RGB2 and the second control signal CS2 and outputs the second image signal RGB2 and the second control signal CS2.

When the single mode signal Smo1 is applied to the second signal divider 253 from the second mode signal inputter 254 by a source, e.g., the user, the second signal divider 253 outputs the second image signal RGB2 and the second control signal CS2 to the second display part 201.

Referring to FIG. 5 and FIG. 6, the second display part 201 displays “CD”, which is the second image RGB2′ corresponding to the second image signal RGB2, using the second image signal RGB2 and the second control signal CS2.

Thus, the first and second display apparatuses 10 and 20 may display respectively the first and second images RGB1′ and RGB2′, which are independent from each other.

In FIG. 5, the second display apparatus 20 may further include a fourth receiver 252 and a second transmitter 255, but the fourth receiver 252 and the second transmitter 255 do not need to be used when the first display apparatus 10 receives the first and second image signals RGB1 and RGB2 from the set-top box 190.

In addition, the third receiver 251 receives the second image signal RGB2 and the second control signal CS2 in FIG. 5, but the fourth receiver 252 may receive the second image signal RGB2 and the second control signal CS2 in other exemplary embodiments.

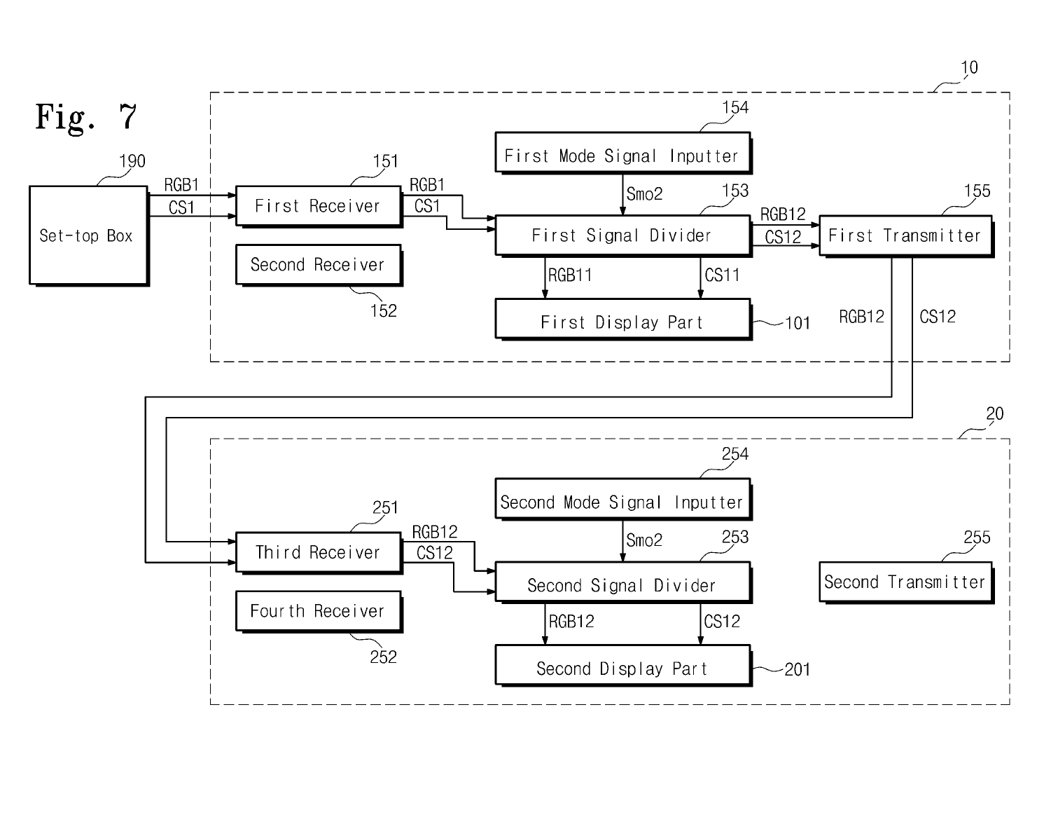

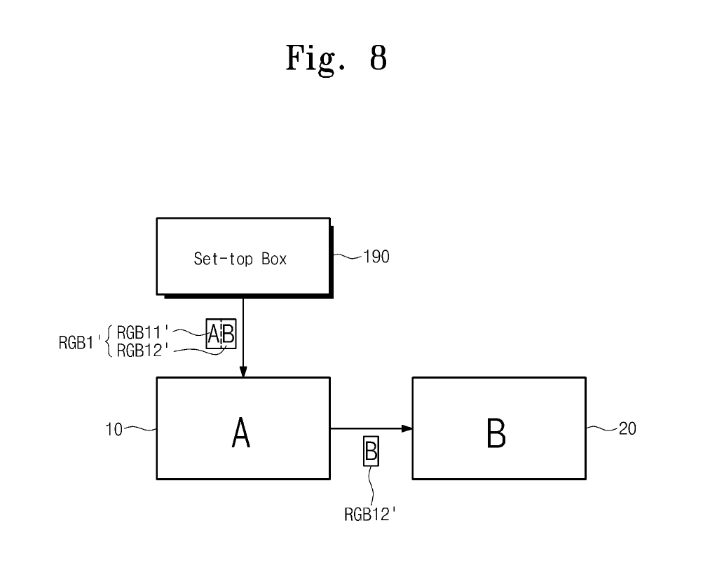

FIG. 7 is a block diagram showing a method of displaying an image using a display apparatus set according to another exemplary embodiment of the present invention, and FIG. 8 is a view showing a process of transmitting an image according to the method shown in FIG. 7.

Referring to FIG. 7 and FIG. 8, a first display apparatus 10 receives a first image signal RGB1 and a first control signal CS1, which are used to display a first image, from a set-top box 190. In FIG. 8, the “AB” of the first image has been shown as the first image RGB1′.

The first image signal RGB1 is divided into a third image signal RGB11 for a third image RGB11′ corresponding to the “A” of the first image RGB1′ and a fourth image signal RGB12 for a fourth image RGB12′ corresponding to the “B” of the first image RGB1′. That is, the first image RGB1′ for the “AB” is spatially divided into a left image and a right image respectively corresponding to the “A” as the third image RGB11′ and the “B” as the fourth image RGB12′. In addition, the first control signal CS1 is divided into a third control signal CS11 used to display the third image RGB11 and a fourth control signal CS12 used to display the fourth image RGB12.

The first display apparatus 10 displays the “A” as the third image RGB11′ corresponding to the third image signal RGB11 using the third image signal RGB11 and the third control signal CS11 and outputs the fourth image signal RGB12 and the fourth control signal CS12 to the second display apparatus 20.

The second display apparatus 20 receives the fourth image signal RGB12 and the fourth control signal CS12 and displays the “B” as the fourth image RGB12′ corresponding to the fourth image signal RGB12.

In detail, referring to FIG. 7, a first receiver 151 receives the first image signal RGB1 and the first control signal CS1 from the set-top box 190 and outputs the first image signal RGB1 and the first control signal CS1 to the first signal divider 153.

When the dual mode signal Smo2 is applied to the first signal divider 153 from the first mode signal inputter 154 according to an instruction, e.g., a user's instructions, the first signal divider 153 outputs the third image signal RGB11 and the third control signal CS11 to the first display part 101, which respectively correspond to portions of the first image signal RGB1 and the first control signal CS1. In addition, the first signal divider 153 outputs the fourth image signal RGB12 and the fourth control signal CS12 (which respectively correspond to remaining portions of the first image signal RGB1 and the first control signal CS1) to the first transmitter 155. The first transmitter 155 may transmit the fourth image signal RGB12 and the fourth control signal CS12 to the third receiver 251 via a wired or wireless connection.

Referring to FIG. 7 and FIG. 8, the first display part 101 displays the “A” as the third image RGB11′ corresponding to the third image signal RGB11 using the third image signal RGB11 and the third control signal CS11.

The third receiver 251 receives the fourth image signal RGB12 and the fourth control signal CS12 and outputs the fourth image signal RGB12 and the fourth control signal CS12 to the second signal divider 253.

When the dual mode signal Smo2 is applied to the second signal divider 253 from the second mode signal inputter 254 according to an instruction, e.g., a user's instructions, the second signal divider 253 outputs the fourth image signal RGB12 and the fourth control signal CS12 to the second display part 201.

Referring to FIG. 7 and FIG. 8, the second display part 201 displays the “B” as the fourth image RGB12′ corresponding to the fourth image signal RGB12 using the fourth image signal RGB12 and the fourth control signal CS12.

Thus, the first and second display apparatuses 10 and 20 may respectively display the third image RGB11′ and the fourth image RGB12′, thereby displaying the “AB” as one image, albeit spatially separated.

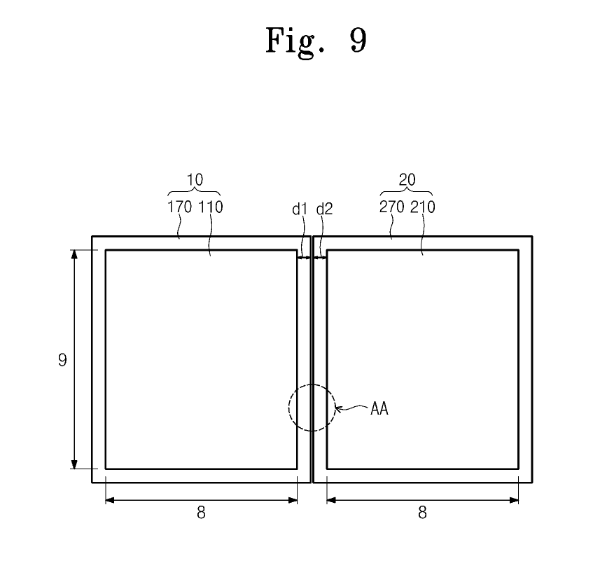

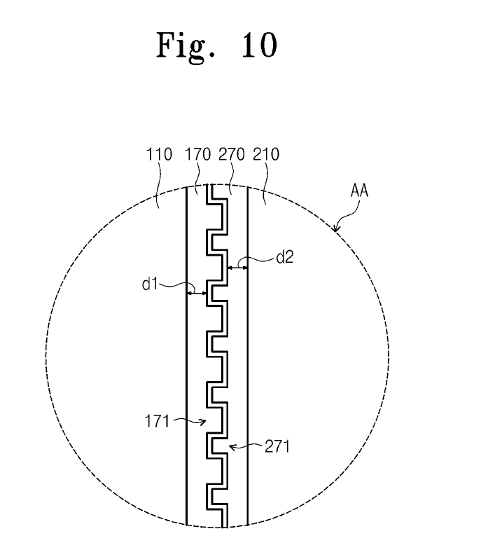

FIG. 9 is a plan view showing a display apparatus set according to an exemplary embodiment of the present invention, and FIG. 10 is a partially enlarged view of portion AA of FIG. 9.

Referring to FIG. 9, the first display apparatus 10 accommodates the first display panel 110 and includes a first chassis 170 to cover at least an end portion of the first display panel 110. The second display apparatus 20 accommodates the second display panel 210 and includes a second chassis 270 to cover at least an end portion of the second display panel 210.

For the convenience of explanation, only the first display panel 110, the second display panel 210, the first chassis 170, and the second chassis 270 have been shown in FIG. 9 and FIG. 10.

Referring to FIG. 10, at least one side surface of the first chassis 170 is provided with a concavo-convex portion, and also at least one side surface of the second chassis 270 is provided with a concavo-convex portion. Convex portions 171 of the concavo-convex portion of the first chassis 170 are alternately arranged with convex portions 271 of the concavo-convex portion of the second chassis 270, so that the first chassis 170 and the second chassis 270 may be coupled with each other by the convex portions 171 and 271. Alternatively, other complimentary patterns may be used for the regions where the first and second chassis 170 and 270 abut. For example, a saw-tooth pattern may be used, or the first and second chassis may have flat edges.

Accordingly, in the case that the first and second display apparatuses 10 and 20 are driven to display one image, the first and second display apparatuses 10 and 20 may be structurally coupled to each other.

The side surface of the first chassis 170 and the side surface of the second chassis 270 have a first width d1 and a second width d2, respectively, and each of the first and second widths d1 and d2 has a size of about 5 mm or less.

Referring to FIG. 9 again, the display screen of the first display apparatus 10 and the display screen of the second display apparatus 20 have the aspect ratio of 8:9. In the case that an image having the aspect ratio of 16:9 is input to the first display apparatus 10, the image having the aspect ratio of 16:9 may be displayed on both of the first and second display apparatuses 10 and 20 by driving the first and second display apparatuses 10 and 20 in the dual mode. Moreover, various aspect ratios of an input image may be displayed on the first and second display apparatus 10 and 20.

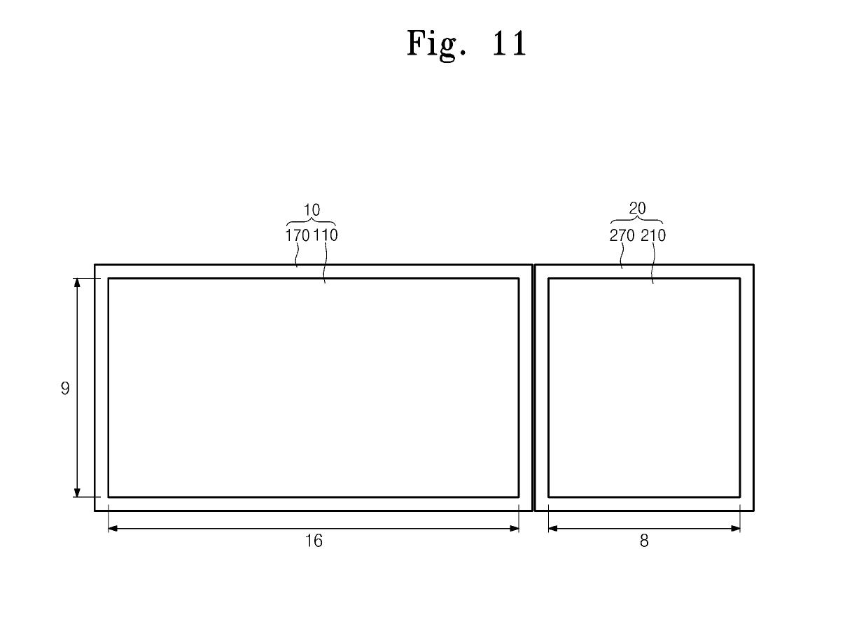

FIG. 11 is a plan view showing a display apparatus set according to another exemplary embodiment of the present invention.

In FIG. 11, a display screen of a first display apparatus 10 has an aspect ratio of 16:9, and a display screen of a second display apparatus 20 has an aspect ratio of 8:9. In the case that an image having an aspect ratio of 24:9 is input to the first display apparatus 10, the image having the aspect ratio of 24:9 may be displayed through both the first and second display apparatuses 10 and 20 by driving the first and second display apparatuses 10 and 20 in the dual mode.

In FIG. 11, the first display apparatus 10 including the display screen having the aspect ratio of 16:9 and the second display apparatus 20 including the display screen having the aspect ratio of 8:9 have been shown, but the display screen of the first display apparatus 10 may have the aspect ratio of 8:9 and the display screen of the second display apparatus 20 may have the aspect ratio of 16:9 according to embodiments.

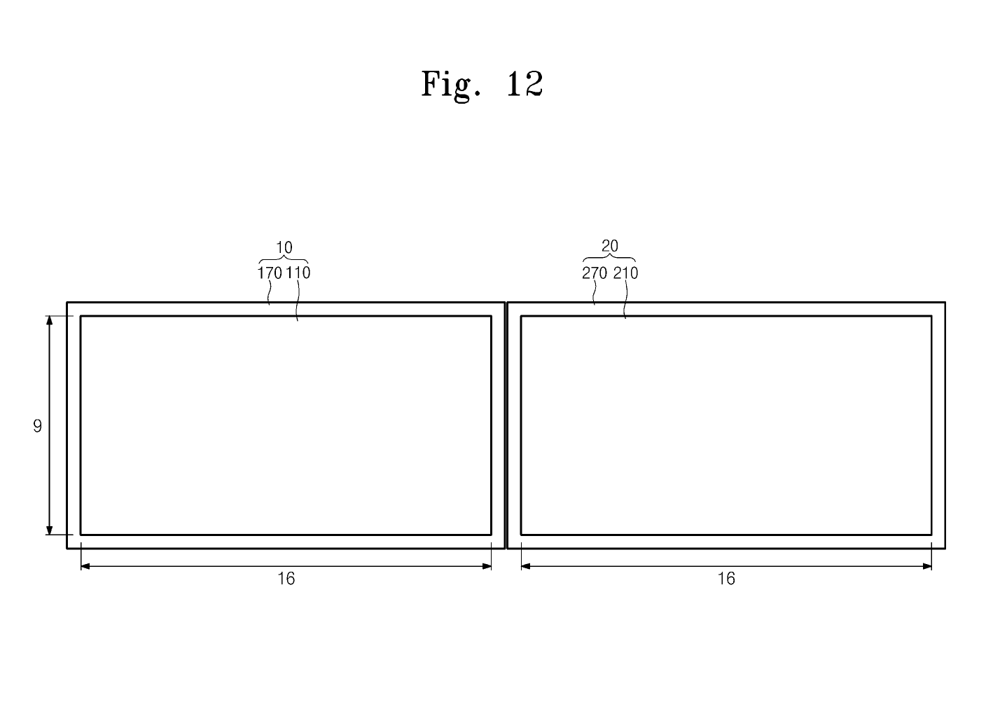

FIG. 12 is a plan view showing a display apparatus set according to another exemplary embodiment of the present invention.

In FIG. 12, a display screen of a first display apparatus 10 has an aspect ratio of 16:9 and a display screen of a second display apparatus 20 has an aspect ratio of 16:9. In the case that an image having an aspect ratio of 32:9 is input to the first display apparatus 10, the image having the aspect ratio of 32:9 may be displayed through both the first and second display apparatuses 10 and 20 by driving the first and second display apparatuses 10 and 20 in the dual mode.

The aspect ratio of the display screen of the first and second display apparatuses 10 and 20 may have other configurations beside those shown in FIG. 9, FIG. 11, and FIG. 12. That is, the aspect ratio of the display screen of the first and second display apparatuses 10 and 20 may be changed. Furthermore, the first and second display apparatuses 10 and 20 may have various configurations. For example, the first display apparatus 10 may be placed on top of the second display apparatus 20, and both the first and second display apparatuses 10 and 20 may have an aspect ratio of 16:4.5. In this case, a concavo-convex portion may be formed on upper and lower surfaces of the first chassis 170 and the second chassis 270, respectively.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A display apparatus set, comprising:
a first signal receiver-transmitter configured to receive an image signal, to output a first portion of the image signal as a first image signal, and to output a second portion of the image signal as a second image signal;
a first scaler configured to receive the first image signal, to convert a size and a resolution of an image included in the first image signal, and to output the converted first image signal;
a first driver circuit configured to receive the converted first image signal, to convert the converted first image signal into a first data signal, and to output the first data signal; and
a first display panel configured to receive the first data signal to display an image.

2. The display apparatus set of claim 1, further comprising:
a second signal receiver/transmitter configured to receive the second image signal and to output the second image signal;
a second scaler configured to receive the second image signal from the second signal receiver/transmitter, to convert a size and a resolution of an image included in the second image signal, and to output the converted second image signal;
a second driving circuit configured to receive the converted second image signal, to convert the converted second image signal into a second data signal, and to output the second data signal; and
a second display panel configured to receive the second data signal to display an image.

3. The display apparatus set of claim 2, wherein the second scaler comprises:
a second image converter to convert the size of the image included in the second image signal; and
a second resolution converter to convert the resolution of the size-converted second image signal.

4. The display apparatus set of claim 2, further comprising:
a first chassis accommodating the first signal receiver-transmitter, the first scaler, the first driving circuit, and the first display panel to cover at least an end portion of the first display panel; and
a second chassis accommodating the second signal receiver/transmitter, the second scaler, the second driving circuit, and the second display panel to cover at least an end portion of the second display panel.

5. The display apparatus set of claim 4, wherein at least one side surface of the first chassis comprises a first concavo-convex portion, at least one side surface of the second chassis comprises a second concavo-convex portion, and convex portions of the first concavo-convex portion are alternately arranged with convex portions of the second concavo-convex portion to couple the first concavo-convex portion to the second concavo-convex portion.

6. The display apparatus set of claim 2, wherein the first display panel comprises a first display area comprising a plurality of pixels and a first non-display area outside of the first display area, and the first display area has an aspect ratio of 8:9.

7. The display apparatus set of claim 6, wherein the second display panel comprises a second display area comprising a plurality of pixels and a second non-display area outside of the second display area, and the second display area has an aspect ratio of 8:9.

8. The display apparatus set of claim 6, wherein the second display panel comprises a second display area comprising a plurality of pixels and a second non-display area outside of the second display area, and the second display area has an aspect ratio of 16:9.

9. The display apparatus set of claim 2, wherein the first display panel comprises a first display area comprising a plurality of pixels and a first non-display area outside of the first display area, and the first display area has an aspect ratio of 16:9.

10. The display apparatus set of claim 9, wherein the second display panel comprises a second display area comprising a plurality of pixels and a second non-display area outside of the second display area, and the second display area has an aspect ratio of 16:9.

11. The display apparatus set of claim 2, wherein the first signal receiver-transmitter comprises:
a receiver comprising a first receiver and a second receiver and configured to receive the image signal and to output the image signal;
a signal divider configured to receive the image signal and to divide the image signal into the first image signal and the second image signal; and
a transmitter configured to receive the second image signal and to output the second image signal.

12. The display apparatus set of claim 11, wherein the first receiver is configured to provide first image signal, the second receiver is configured to provide the second image signal, and the first display panel and the second display panel are configured to be independently driven to display separate images respectively corresponding to the first image signal and the second image signal.

13. The display apparatus set of claim 11, wherein the first receiver is configured to provide the image signal, the first image signal and the second image signal are obtained by dividing the image signal, and the first display panel and the second display panel are configured to be dependently driven to display one image.

14. The display apparatus set of claim 11, wherein the transmitter is configured to wirelessly transmit the second image signal, and the second signal receiver/transmitter is configured to wirelessly receive the second image signal from the wireless connection.

15. The display apparatus set of claim 11, wherein the transmitter is configured to transmit the second image signal via a wired connection, and the second signal receiver/transmitter is configured to receive the second image signal from the wired connection.

16. The display apparatus of claim 1, wherein the first scaler comprises:
a first image size converter to convert the size of the image included in the first image signal; and
a first resolution converter to convert the resolution of the size-converted first image signal.

17. A display apparatus set, comprising:
a first display apparatus configured to receive an image signal, to display an image corresponding to a first image signal that comprises a first portion of the image signal, and to output a second image signal that comprises a second portion of the image signal; and
a second display apparatus configured to receive the second image signal output from the first display apparatus to display an image corresponding to the second image signal.

18. The display apparatus set of claim 17, wherein the first image signal comprises a first image, the second image signal comprises a second image that is different from the first image, and the first display apparatus and the second display apparatus are configured to be independently driven to display separate images.

19. The display apparatus set of claim 17, wherein the image signal comprises a first image, the first image signal and the second image signal are obtained by spatially dividing the first image, and the first display panel and the second display panel are configured to be dependently driven to display one image.

20. A display apparatus set, comprising:
a first signal receiver/transmitter configured to receive an image signal, to output a first portion of the image signal as a first image signal, and to output a second portion of the image signal as a second image signal;
a second signal receiver/transmitter configured to receive the second image signal and to output the second image signal;
a first display panel configured to receive a first data signal from the first signal receiver/transmitter to display a first image; and
a second display panel configured to receive a second data signal from the second signal receiver/transmitter to display a second image.

21. A method of displaying an image using a first display apparatus and a second display apparatus, the method comprising:
in a first mode:
receiving a first image signal and a second image signal different from the first image signal at the first display apparatus;
transmitting, by the first display apparatus, the second image signal to the second display apparatus; and
displaying a first image corresponding to the first image signal using the first display apparatus, and displaying a second image corresponding to the second image signal using the second display apparatus; and
in a second mode:
receiving an image signal at the first display apparatus, the image signal corresponding to a third image;
transmitting, by the first display apparatus, a first portion of the image signal to the second display apparatus; and
displaying a fourth image corresponding to a second portion of the image signal using the first display apparatus, and displaying a fifth image corresponding to the first portion of the image signal using the second display apparatus,
wherein the fourth image and the fifth image together form the third image.

22. A display apparatus, comprising:
a signal receiver/transmitter configured to receive an image signal;
a signal divider to output a portion of the image signal as a first image signal, and to output a second portion of the image signal as a second image signal;
a scaler configured to receive the first image signal, to convert a size and a resolution of an image included in the first image signal, and to output the converted first image signal;
a driver circuit to receive the converted first image signal and provide a data signal to a display panel configured to receive the first data signal to display an image.

23. The display apparatus of claim 22, further comprising a first chassis accommodating the signal receiver/transmitter, the scaler, the driving circuit, and the display panel to cover at least an end portion of the display panel.

24. The display apparatus set of claim 22, wherein the display panel comprises a display area comprising a plurality of pixels and a non-display area outside of the display area, and the display area has an aspect ratio of 8:9.

25. The display apparatus set of claim 22, wherein the display panel comprises a display area comprising a plurality of pixels and a non-display area outside of the display area, and the display area has an aspect ratio of 16:9.

26. The display apparatus set of claim 22, wherein the signal receiver/transmitter comprises:
a receiver comprising a first receiver and a second receiver and configured to receive the image signal and to output the image signal; and
a transmitter configured to receive the second image signal and to output the second image signal.

27. The display apparatus set of claim 26, wherein the transmitter is configured to wirelessly transmit the second image signal via a wireless connection.

28. The display apparatus of claim 22, wherein the scaler comprises:
an image size converter to convert the size of the image included in the first image signal; and
a resolution converter to convert the resolution of the size-converted first image signal.
